(19) United States
(12) Patent Application Publication
(10) Pub. No.: US 2008/0087124 A1
(43) Pub. Date: Apr. 17, 2008

(54) ENVELOPING SPEED REDUCER

(76) Inventor: Yakov Fleytman, Flowery Branch, GA (US)

Correspondence Address: YAKOV FLEYTMAN, 6358 CHESNUT PARKWAY, FLOWERY BRANCH, GA, 30542, US

(21) Appl. No.: 11/952,935

(22) Filed: Dec. 7, 2007

Related U.S. Application Data
(63) Continuation of application No. 10/854,363, filed on May 27, 2004.

(51) Int. Cl. F16H 1/16; F16H 55/02

(52) U.S. Cl. 74/427

(57) ABSTRACT

A speed reducer is provided with housing having support for a shaft of an enveloping worm and a shaft of a face gear. The enveloping worm placed into meshing engagement with the face gear. They have crossing or intersected axes. The enveloping worm face gears are used for mechanical power transition while reducing the noise and the weight of the speed reducer. It can replace worm, double helical, spiral bevel or hypoid gears

This is a continuation-in-part of Ser. No. 10/854,363 filed May 27, 2004.

The present invention relates generally to gears reducers, and more particularly, to gears box having an enveloping or globoid worm in mesh with a mating gear. This type of speed reducer could be used in medical devices industrial, automotive applications, and any mechanical power reduction systems.

### BACKGROUND OF THE INVENTION

### Field of the Invention

Enveloping worm speed reducers, particular double enveloping worm gear drive are used in various applications as a high ratio, more than 5:1 of mechanical drive. In double enveloping speed reducer a pinion shaft and mating worm gear shafts are crossed. (U.S. Pat. No. 1,980,237 by Trbojevich, U.S. Pat. No. 5,836,076 by Duta and Prom: U.S. Pat. No. 5,018,403 by Umezono and Maki). Conventional enveloping worm/worm gear transmissions are using worm thread with at least one revolution of the thread or more than 360 degrees of revolution.

Usually, face gear has straight side worm engagement in mesh with a face (ring) gear. U.S. Pat. No. 6,128,969 by Litvin et al.

Litvin teaches that a cylindrical worm pinion is in meshing engagement with a face gear in housing that supports said cylindrical pinion and said face gear wherein said worm pinion and said face gear axes are crossed.

This cylindrical worm pinion has threads with less than one revolution and has standard pinion profile with unequal pressure angles for driving and coast surfaces, but the pressure angle is constant for driving surface and is constant for the coast surface.

### SUMMARY OF THE INVENTION

Accordingly, it is an object of the present invention to provide a speed reducer with wide range of ratios: 5:1 or more and even with ratio less than 5:1. It is a further object of the present invention to be able to substitute existing speed reducers using worm, double helical spiral bevel or hypoid gears, where input and output shafts are intersected or crossed.

These and other objects of the present invention are obtained by providing a speed reducer with a unique enveloping worm face gearset, where enveloping worm pinion has a thread with convex surface on one working side and concave surface on another working side. Said enveloping worm thread has variable pressure angle on the concave surface and variable pressure angle on the convex surface. On the pinion side with bigger outside diameter the concave surface has smaller pressure angle than the pressure angle on the convex surface. The pressure angle on concave surface becomes bigger toward smaller outside diameter of the pinion and the pressure angle on the convex surface becomes smaller toward smaller outside diameter of the pinion.

In particular, this unique enveloping-type worm mounted thereto is meshed with a face type worm gear, where face worm gear teeth having a tooth surface is generated by a profile of the enveloping worm.

Enveloping worm or globoid worm of a face gear transmissions have not been known. Thus, those skilled in the art did not consider enveloping type worm gears in mesh with a face type worm gear to be feasible for commercial applications. In contrast, the enveloping face worm gears of the present invention utilize a worm gear that is easily manufactured.

Rolling motion with small percentage of sliding motion significantly increases efficiency of an enveloping speed reducer. For the same size, this invention has more torque capacity of traditional worm or spiral bevel gears. Suction tooth action makes excellent tooth lubrication that also reduces heat. It allows different casting designs from not very heat conductive materials, even from plastic or ceramic. As compared to prior worm, cross helical, spiral bevel or hypoid gear speed reducers, enveloping worm face speed reducer is more compact, quiet and efficient. Thus, the present invention can replace worm, double helical, bevel or hypoid gears in many applications, including powertrain applications.

In the present invention, the enveloping worm can be with less than one revolution of threads or more than one revolution of threads having one or more threads, which can have only one supporting shaft. Further areas of applicability of the present invention will become apparent from the comprehensive description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this complete description.

### BRIEF DESCRIPTION OF THE DRAWINGS

The present invention will become more fully understood from the details described below:

FIG. 1 is an isometric view of a design with less than 180 degree of thread revolution of an enveloping worm pinion placed on the face of a worm gear, where enveloping worm pinion shaft and said face gear shaft are intersected.

FIG. 2 is a top view of a speed reducer with enveloping worm face gears with crossing axes between enveloping worm shaft and face gear shaft according to the principles of the present invention.

FIG. 3 is a side view of a speed reducer with enveloping worm face gears with crossing axes between enveloping worm shaft and face gear shaft according to the principles of the present invention.

FIG. 4 is a top view of a speed reducer with enveloping worm face gears with crossed axes between enveloping worm pinion shaft and face gear shaft according to the principles of the present invention.

FIG. 5 is an isometric view of a speed reducer with enveloping worm face gears with crossed axes between enveloping worm pinion shaft and face gear shaft according to the principles of the present invention.

FIG. 6 is an isometric view of a gear train as a combination of two pairs of enveloping face worm sets, where enveloping worm pinion shaft of first pair of sets and face gear shaft of second pair of gear sets are crossed.

FIG. 7 is an isometric view of a gear train as a combination of two pairs of enveloping face worm sets, where enveloping worm pinion shaft of first pair of sets and face gear shaft of second pair of gear sets are intersected.

FIG. 8 is a front view of the pinion from FIG. 1.

FIG. 9 is a back view of the pinion from FIG. 1.

FIG. 10 is an isometric view of a pinion with more than 360 degrees of one thread revolutions in mesh with a face gear.

### DETAILED DESCRIPTION OF THE PREFERRED EMBODIMENTS

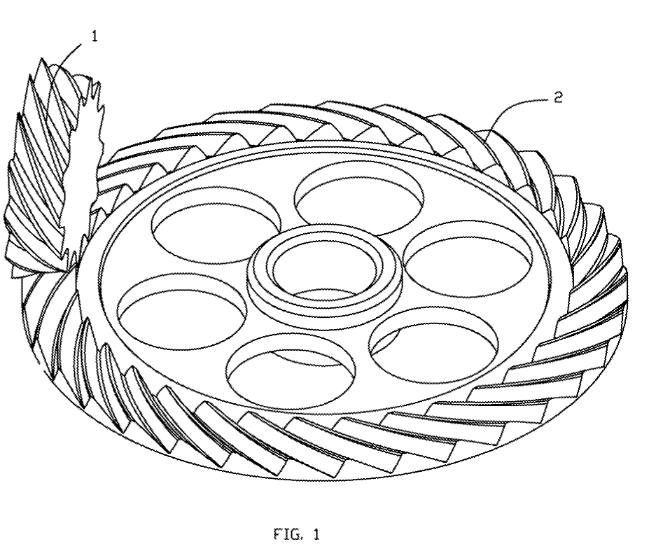

As will be detailed, an enveloping speed reducer with a unique worm-type input gearset embodying the principles of the present invention will be described below with reference to FIGS. 1 through 9. Initially, however, the following discussion provides a complete description of the enveloping worm face gear transmissions used for the worm-type-input gearset. Prior to specific consideration of the drawings, several unique features of the present invention can be discussed. In particular, the present invention is directed to gearsets having an enveloping worm face gear, where an enveloping worm is placed in mesh with a face gear. This type of gear produces contact pattern along the gear tooth line: from the left to the right or from the right to the left depending on the direction of rotation. This motion of contact pattern is very different from motion of contact pattern of any gears, used in drive axle assemble. For example in hypoid or spiral bevel gears contact pattern in motion is across the gear tooth: from the root to the tip or from the tip to the root depending on the direction of rotation.

The reason for using an enveloping worm in mesh with a face gear is more torque capacity via surface-to-surface contact between the enveloping worm gear teeth and the face gear.

Referring now to the drawings:

FIG. 1 is an isometric view of a design with enveloping worm 1 placed in the middle of the face of worm gear 2 with enveloping worm threads having less than 180 degrees of revolution.

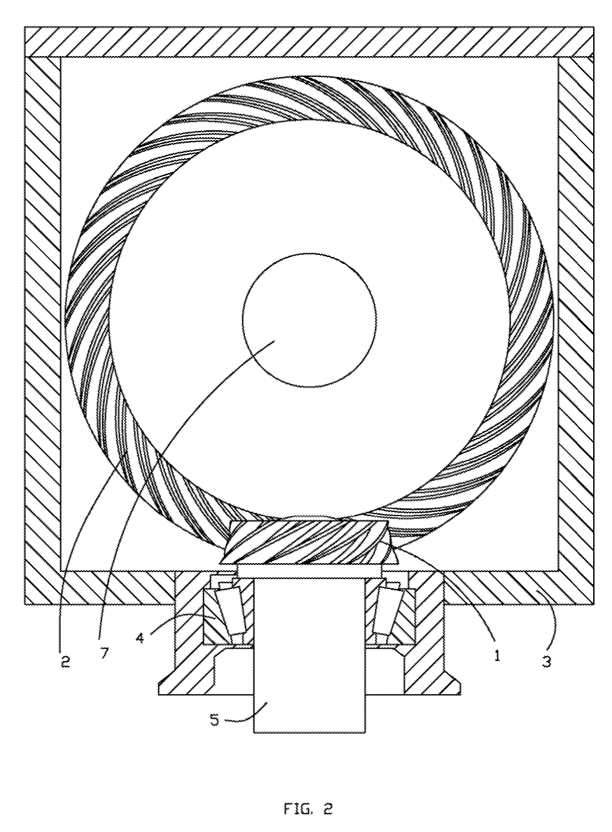

FIG. 2 is a top view of a housing 3 with enveloping worm 1 placed in the middle of the face of worm gear 2 with enveloping worm threads having less than 180 degrees of revolution. Bearing 4 provides bearing support for shaft 5 of said enveloping pinion 1.

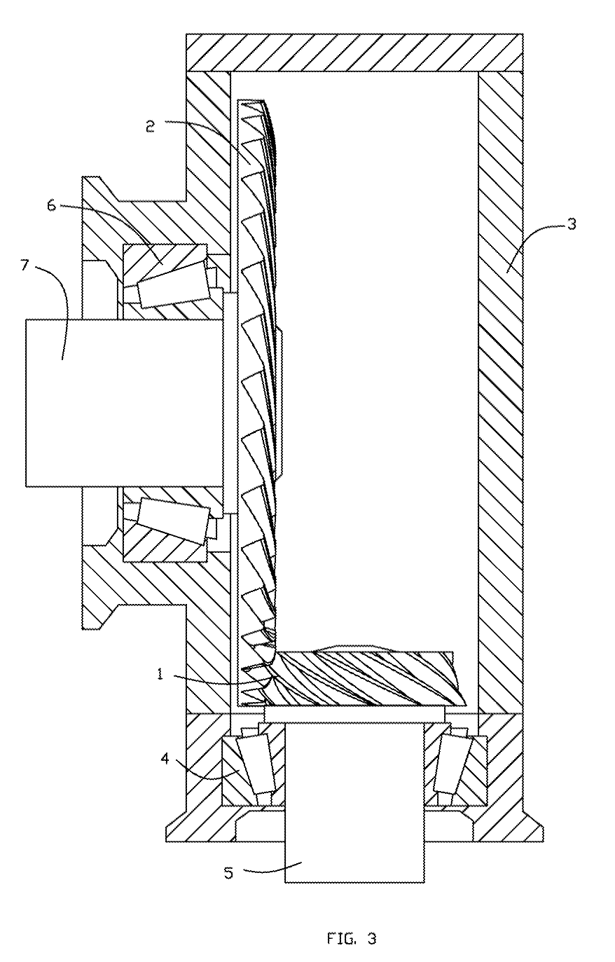

FIG. 3 is a side view of a housing 3 with enveloping worm 1 placed in the middle of the face of worm gear 2 with enveloping worm threads having less than 180 degrees of revolution. Bearing 4 provides bearing support for shaft 5 of said enveloping pinion 1, and bearing 6 provides bearing support for shaft 7 of said face gear 2.

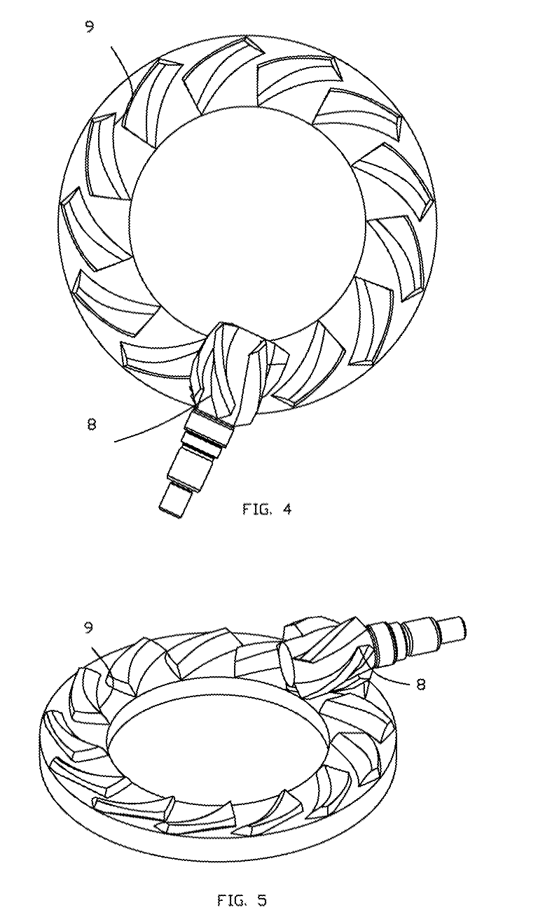

FIG. 4 is a view of a design with an enveloping worm 8 placed on the face of worm gear 9 with offset and with enveloping worm threads having 90 degrees of revolution.

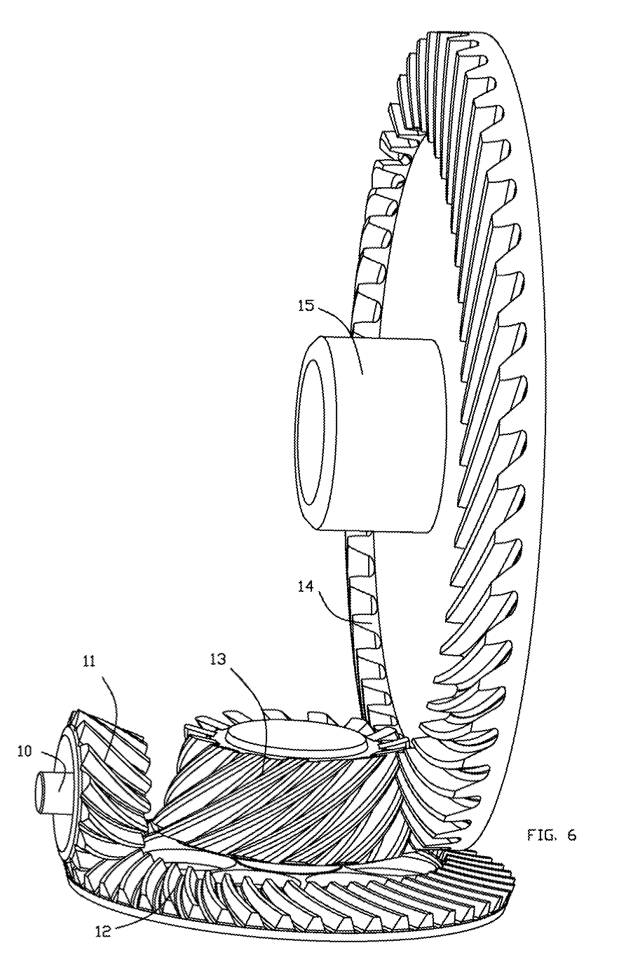

FIG. 5 is an isometric view of a design with an enveloping worm 8 placed on the face of worm gear 9 with offset and with enveloping worm threads having 90 degrees of revolution.

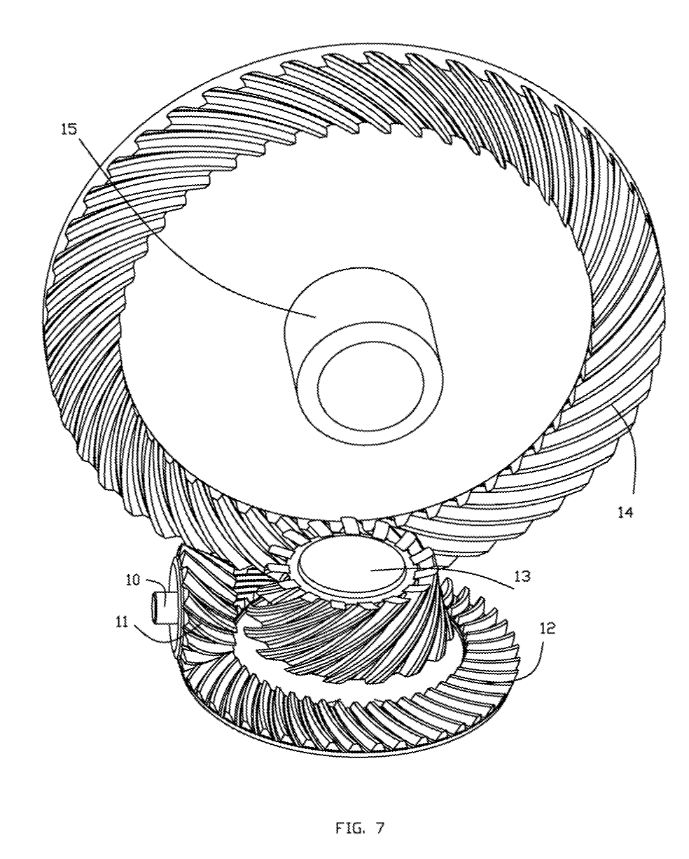

According with gear train in FIG. 6, where first pair of right angle gear set having input shaft 10 with pinion 11 in mesh with gear 12 and second pair of right angle gear set having pinion 13 in mesh with gear 14 and at least first or second pair of right angle gear sets is enveloping pinion face gear set. Shaft 15 is output shaft.

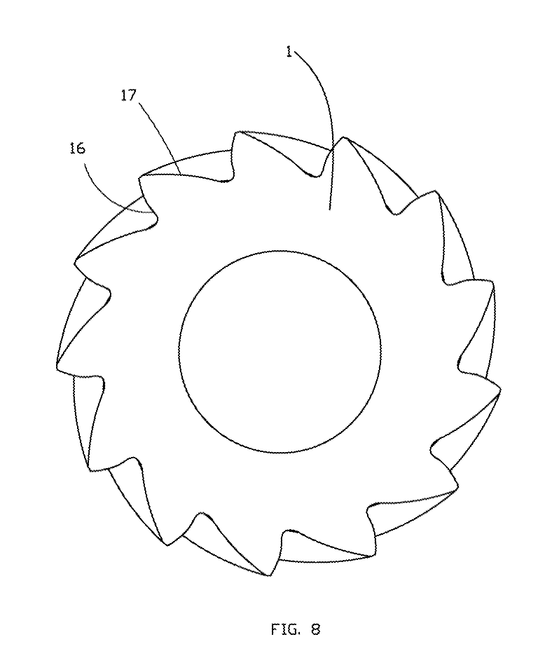

FIG. 7 is the same gear train as shown in FIG. 6, but position of the pinion 11 on the face gear 12 is changed. It makes crossed angle between input shaft 13 and output shaft 15.

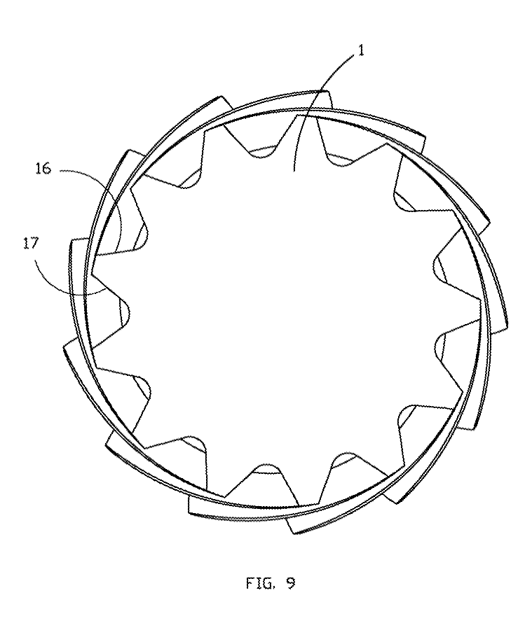

FIG. 8 is a front view of the pinion 1 from FIG. 1.

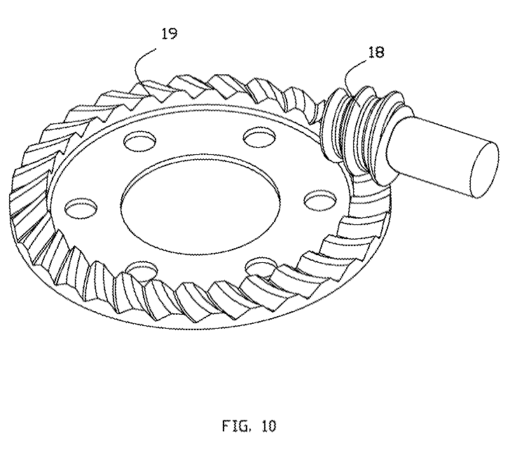

FIG. 9 is a back view of the pinion 1 from FIG. 1.

FIG. 10 is a view of a design with an enveloping worm 18 placed on the face of worm gear 19 and the enveloping worm thread having more than 360 degrees of revolution.

Combinations of enveloping worm face gears according with FIG. 6 and FIG. 7 are used for increasing ratio of speed reducer.

New enveloping worm transmission is comprised of and enveloping worm 1 and worm gear 2. Worm 1 has at least one screw thread that is engaged by at least one tooth of said worm gear 2 wherein worm gear 2 is a face gear. Enveloping worm pinion 1 is placed into face arrangement with worm gear 2. The profile of enveloping worm thread could be produce from mathematical equations, computer simulation or machined by a special program, but it is not the same enveloping worm that is used as a pinion for double enveloping gears, where the enveloping worm pinion is placed in the original position in meshing engagement on the top of the worm gear, not on the face of the worm gear. In this enveloping worm face transmission the enveloping worm thread has variable pressure angle on the concave surface 16 and variable pressure angle on the convex 17 surface. On the pinion side with bigger outside diameter (FIG. 8) the concave surface has smaller pressure angle than the pressure angle on the convex surface. The pressure angle on concave surface becomes bigger toward smaller outside diameter of the pinion and the pressure angle on the convex surface becomes smaller toward smaller outside diameter of the pinion (FIG. 9).

This is a non obvious usage of well known enveloping worm. By repositioning the enveloping worm thread from its original position into face engagement with a worm gear makes the profile of the worm gear also very different from profile of the worm gear of double enveloping worm gears.

In standard double enveloping gearing each convex surface on one side of the thread becomes the concave surface and each concave surface of another side of the thread becomes the convex surface. The proposed enveloping worm pinion does not have standard profile. In the proposed speed reducer the use of threads with only concave surface on the one side of the thread and convex surface on another side of the thread is preferred. The enveloping worm threads with only concave surface on one side and convex surface on another side have more than 360 degrees or less than one revolution. They can have less than 180 degrees of revolutions or even less than 90 degrees of revolutions. Longer worm thread has better contact ratio and for low kinematics ratios (for example, less than 8:1) it is more efficient. The shape and material of housing 3 may have many different variations. Bearing support 4 for every design can be calculated according with engineering practice.

### Advantages of an Enveloping Speed Reducer

Transmit More Power with Smaller Gears.

Compact Alternative for Speed Reducers with Worm, Cross Helical, Hypoid or Spiral Bevel Gears.

Enveloping worm face gears have high torque capacity due to surface to surface contact mesh that reduces contact stresses. It saves up to 30% of space and significantly reduces weight. For the same size, this invention can provide more capacity of worm, spiral bevel or hypoid gearing. The possibility to reduce number of gear teeth of the present invention due to high contact ratio makes each tooth thicker and therefore stronger.

Efficiency is Extremely High

In standard double enveloping worm gearing the enveloping worm thread has partially a rolling but mostly sliding action contact relationship with the teeth of the worm gear. Worm and cross helical gears are have always been used in the speed reducers, but enveloping worm face speed reducer is more efficient, especially for highest ratio applications. The enveloping worm thread has a rolling action contact relationship with the teeth of the face gear, which provides an increased efficiency. It has higher percentage of rolling/sliding motion and excellent dynamic lubrication. It has extended life even without lubrication. For back drive, where the face gear is a driven member and the enveloping worm is a driving member, this speed reducer also has high efficiency compared to a spiral bevel or hypoid gear set.

Lower Noise

Each thread of the pinion is in mesh with two teeth most of the time. It reduces impact of engagement and disengagement, increases the contact ratio and makes quieter motion. The lower noise of the enveloping worm face speed reducer gear compared to worm, cross helical, hypoid or bevel speed reducers makes using the present invention more beneficial in powertrain applications.

Manufacturability

A computer model simulation can be utilized to generate the surface of the worm gear tooth by using enveloping worm pinion profile as a material remover during moving meshing engagement with face gear blank. The worm gear can also be formed using known techniques such as hobbing by using profile of the enveloping worm pinion as a master gear. It is possible to make proposed enveloping pinion without undercuts.

Using existing multi axis machines or spiral bevel, hypoid or helical gear cutting machines can make enveloping worm face speed reducer not more expensive than hypoid, spiral bevel or helical gears. For some configuration, forging technology or power metallurgy could be applied as well.

Proposed Combination Shows the Novel Physical Feature

The prior-art references do not contain any suggestion (express or implied) that they be combined, or that they be combined in the manner suggested, when enveloping pinion has a thread only with a convex surface on one working side and only concave surface on another working side and moreover said enveloping worm thread has variable pressure angle on the concave surface and variable pressure angle on the convex surface, where on the pinion side with bigger outside diameter the concave surface has smaller pressure angle than the pressure angle on the convex surface and pressure angle on concave surface becomes bigger toward smaller outside diameter of the pinion and the pressure angle on the convex surface becomes smaller toward smaller outside diameter of the pinion.

Double enveloping worm gearing has a high load (torque) capacity due to high contact ratio because enveloping worm wraps mating worm gear. Cylindrical worm has contact with mating worm gear only on the top of the gear and the result is limited contact ratio and lower load capacity. An explicit prior art of double enveloping pinion teaches or makes suggestion of increase contact ratio by increasing number of mating teeth. But when enveloping worm is engaged in the mesh with a face gear they have less or equal contact ratio to cylindrical worm in the face gear mesh. For the person having ordinary skill in the art, suggestion or motivation to expect higher contact ratio by transferring benefits of double enveloping into enveloping pinion with face gear engagement does not work.

In the present application, it is a surface-to-surface contact between the enveloping worm gear teeth and the face gear that increases the torque capacity of the speed reducer. This is not obvious and unpredictable for the person having ordinary skill in the art and produces new and unexpected results.

Several embodiments of the present invention have been disclosed. A worker of ordinary skill in the art would recognize that certain modifications would come within the scope of this invention.

What is claimed is:

1. An enveloping speed reducer comprising of an enveloping worm pinion in meshing engagement with a face gear;
a housing that supports said enveloping pinion and said face gear;
said enveloping worm thread has variable pressure angle on the concave surface and variable pressure angle on the convex surface;
wherein on the pinion side with bigger outside diameter the concave surface has smaller pressure angle than the pressure angle on the convex surface;
wherein the pressure angle on concave surface becomes bigger toward smaller outside diameter of the pinion and the pressure angle on the convex surface becomes smaller toward smaller outside diameter of the pinion.

2. An enveloping speed reducer as recited in claim 1 wherein said enveloping worm pinion has a thread with convex surface on one working side and concave surface on another working side.

3. An enveloping speed reducer as recited in claim 1 wherein said enveloping worm pinion and said face gear axes are crossed.

4. An enveloping speed reducer as recited in claim 1 wherein said enveloping worm pinion shaft and said face gear axes are intersected.

5. An enveloping speed reducer as recited in claim 1 wherein said enveloping worm pinion has threads with less than one revolution.

6. An enveloping speed reducer as recited in claim 1 wherein said enveloping worm pinion has threads with less than 180 degrees of revolution.

7. An enveloping speed reducer as recited in claim 1 wherein said enveloping worm pinion has thread with more than 360 degrees of revolution.
